(19) United States
(12) Patent Application Publication
(10) Pub. No.: US 2022/0071319 A1
(43) Pub. Date: Mar. 10, 2022

(54) Personal Ventilation System for an Air Mask

(71) Applicant: John Bruneau, Freeport, FL (US)

(72) Inventor: John Bruneau, Freeport, FL (US)

(21) Appl. No.: 17/159,303

(22) Filed: Jan. 27, 2021

Related U.S. Application Data
(60) Provisional application No. 63/074,503, filed on Sep. 4, 2020.

(51) Int. Cl. A41D 13/11; A62B 18/10; A62B 23/02

(52) U.S. Cl. CPC A41D 13/1107; A41D 13/1161; A62B 23/025; A62B 18/10

(57) ABSTRACT

This present invention relates to personal protection equipment, and in particular to a face mask having a positive or forced air flow provided by a portable pump to the interior of the face mask. The face mask system reduces the amount of carbon monoxide the wearer is exposed to by providing a one-way valve system which closes to allow the expelled carbon monoxide to dissipate. The face mask system serves to force out previously expelled air through on or more vents located in the mask.

### CROSS-REFERENCE TO RELATED APPLICATION

The present application claims priority to, and the benefit of, U.S. Provisional Application No. 63/074,503, which was filed on Sep. 4, 2020 and is incorporated herein by reference in its entirety.

### FIELD OF THE INVENTION

The present invention relates to the field of personal protection equipment. More specifically, the present invention relates to a face mask having a ventilation system to filter incoming air and extract exhaled air from behind the mask to facilitate easier and less labored breathing by the individual wearer. Accordingly, the present specification makes specific reference thereto. However, it is to be appreciated that aspects of the present invention are also amenable with other like applications, devices and methods of manufacture.

### BACKGROUND OF THE INVENTION

There is increased usage of and demand for personal protection equipment during periods of disease such as the ongoing COVID-19 pandemic, periods of poor air quality alerts (e.g., ozone alerts), and other events which can contribute to the spread of infections or disease, and contribute to respiratory difficulty. Face masks and face shields are but one of many options an individual may employ or use in order to provide some level of safety and protection from the spread of disease. Face shields and face masks generally cover the nose and mouth of the individual wearer, and are meant to filter out at least some of the airborne pathogens, germs, microbes, contaminants, particulates, contagions and the like that the wearer may otherwise breathe in. Similarly, face shields and face masks are also useful is slowing the spread of disease by filtering at least some of the airborne pathogens, germs, microbes, contaminants, particulates, contagions and the like that an infected individual may otherwise breath into a public space.

Unfortunately, face shields are not particularly effective other than from preventing the user from encountering bacteria, viruses or other particulate which the wearer encounters from a head on situation. For example, if someone speaks or sneezes in front of the wearer, then the face shield serves to block the directional flow or air current carrying the airborne particles or other matter. However, the wearer of a face shield still has to breathe the air that is present in his or her environment, as the shield typically is not sealed to the user's face and air and other contaminants may enter from around, under or over the shield. Face shields also generally require additional carrying apparatus, such as a head band that loops around the user's head, or alternatively, they can be connected to a pair of glasses or a frame from which the shield is suspended. When not in use, face shields are then pivoted up toward the head band, and if the user forgets the shield is up he or she may bump into door frames or other things due to the extension of the shield. This creates additional bulkiness for the wearer. Accordingly, face shields can be cumbersome in use due to their size, weight and shape.

There are also many types of face masks available today to help the wearer remain safe by covering the nose and mouth of the individual. Many of such face masks are disposable, and relatively inexpensive. However, most such face masks provide little to no air circulation, and can be uncomfortable to wear when the individual is exerting any effort, such as during exercising, walking, running or the like. Additionally, face masks have different degrees of effectiveness based on the particle size that the mask is intended to prevent from entering the mask. For example, some highly efficient masks will capture particles of 3 microns or larger. However, depending on the weave or construction of the mask, air flow may be challenging and wearing the mask may actually contribute to the respiratory difficulty of the user, particularly during hot and humid days as air does not easily pass through the material in either direction, leading the wearer to rebreathe carbon dioxide expelled by the user when breathing into the mask while it is being worn on the face of the individual. In addition, the air passing through the mask material may also contain odors, scents and other fragrances which may or may not be appealing to the user, and the individual must endure the odiferous smell until it passes.

Therefore, there exists a long felt need in the art for an improved face mask system that overcomes the drawbacks of existing face masks and face shields, and prevents the user from having to rebreathe significant amounts of carbon dioxide laden air as well as air that may contain odors or other unpleasant smells for the user. There is also a long felt need in the art for an improved face mask system that does not result in laborious breathing or shortness of breath on the part of the wearer. Moreover, there is a long felt need in the art for an improved face mask system that results in cleaner air being both inhaled and exhaled, and that reduces the possibility of disease transmission. Finally, there is a long felt need in the art for an improved face mask system that is relatively inexpensive to manufacture and that is both safe and easy to use.

As explained more fully herein, the improved face mask system of the present invention, in its various potential embodiments, accomplishes all of the forgoing objectives, and substantially departs from the concepts and designs of the conventional.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The instant invention is a self-contained face mask system that provides regular air flow to the interior surface of the face mask, which is covering the nose and mouth region of the wearer. The face mask system of the present invention reduces the rebreathing of exhaled carbon dioxide by the face mask wearer, which often accompanies the wearing of a face mask and can contribute to respiratory distress. By providing a portable and lightweight pump to drive fresh air to the user, the flow of air, and more particularly the amount of carbon dioxide present in the region covering the nose and mouth, can be controlled by a one-way valve to aid in allowing accumulated carbon dioxide to be depleted in the nose and mouth region of the interior of the face mask.

In one exemplary embodiment of the presently described invention, an air mask system is disclosed and includes a face mask that is designed to cover a nose and mouth region of a wearer. The face mask has a pair of loops to hold the face mask in proper position over the nose and mouth region of the wearer, wherein the face mask has at least one woven or non-woven layer, a front side, a back side, an upper edge, and a lower edge. At least one filter is integrated into the face mask, and a pump is connected via tubing to the face mask. The pump provides a regular flow of fresh air and oxygen to the nose and mouth region of the interior of the face mask.

In a further exemplary embodiment of the presently described invention, a combination pump and face mask is provided, and comprises a face mask with first and second sides, a top edge and a bottom edge. The face mask further comprises a pair of ear loops for holding the face mask in proper position over a mouth and nose region of a wearer. A portable battery powered pump is connected to the face mask by left and right tubing segments. The pump has a filter which may contain charcoal or other filtering media, and the pump further comprises a one-way or check valve to facilitate the removal of carbon dioxide from inside the face mask.

In a still further exemplary embodiment of the presently described invention, personal protection equipment is disclosed and includes a face mask that is manufactured from one of a woven or non-woven material. The face mask sized and configured to cover the nose and mouth region of an individual, and is comprised of an outer surface, an inner surface, an upper edge and a lower edge. The face mask further comprises a pair of filters, each extending from the outer surface to the inner surface, and a nose piece provided on the upper edge of the face mask. The nose piece is comprised of first and second ends, wherein each of the first and second ends is connected to a flexible tube extending from the nose piece to around a head of a wearer. The personal protection equipment further comprises a pump that is in fluid communication with the flexible tube, wherein the pump provides a regular source of fresh air to the inner surface of the face mask, particularly in the nose and mouth region of the individual.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the air mask system of the present invention in accordance with the disclosed architecture and showing the inner surface of the mask being in fluid communication with a portable pump;

FIG. 2 illustrates a perspective view of one potential embodiment of the portable pump of the air mask system of the present invention in accordance with the disclosed architecture, wherein the pump is used to generate a positive air flow for the air mask system of the present invention;

FIG. 3 illustrates a perspective view of one potential embodiment of the outer surface of the face mask portion of the air mask system of the present invention in accordance with the disclosed architecture;

FIG. 4 illustrates a partial perspective view of one potential embodiment of the face mask of the air mask system of the present invention in accordance with the disclosed architecture, and showing the multi-ply configuration of the face mask; and

FIG. 5 illustrates a perspective view of a tube that can be installed between an existing mask and the air mask system of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention or do not limit the scope of the invention. Additionally, an illustrated embodiment need not have all the aspects or advantages shown. Thus, in other embodiments, any of the features described herein from different embodiments may be combined.

The present invention relates to a face mask and pump system combination which is used to provide a regular supply of clean air to the interior portion of the face mask. As a point of reference, the interior portion or surface of the face mask refers to that surface or side of the face mask that is directed towards, and immediately adjacent to, the face of the wearer, wherein the exterior portion or surface of the face mask refers to that surface or side of the face mask that is directed outwardly, or away from, the face of the wearer. Among other things, the face mask and pump system combination of the present invention is also designed to facilitate the efficient removal of carbon dioxide from the nose and mouth region of the wearer. More specifically, through the use of a one-way or check valve system, expelled carbon dioxide from the wearer is allowed to dissipate after each exhale, and is forced from the interior space of the face mask by the incoming air supply. The portable and light weight pump of the present invention can be easily clipped onto the collar or other apparel of the individual wearer, and carried with the system as needed. The pump is preferably battery powered, and may also utilize a rechargeable battery and a USB connection for recharging the rechargeable battery.

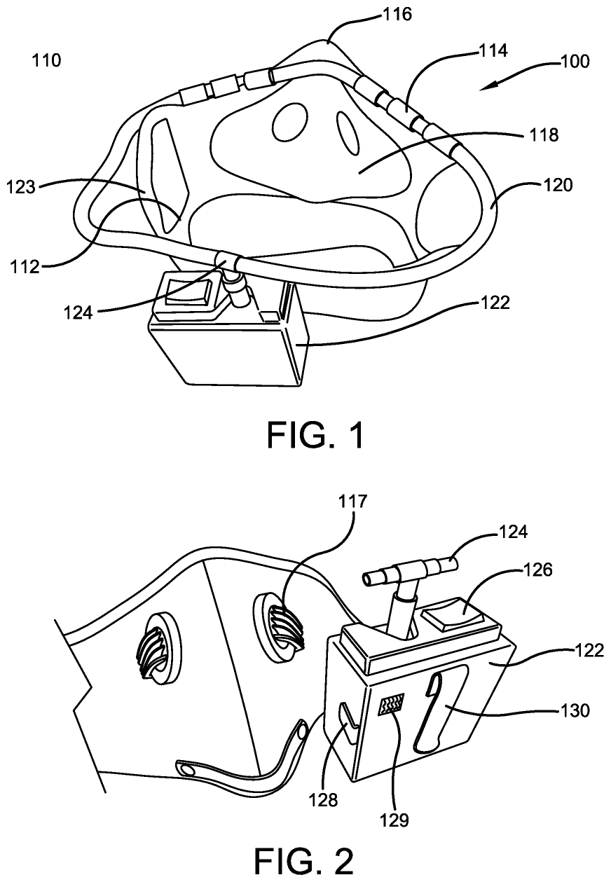

Referring now to the drawings, FIG. 1 illustrates a perspective view of one potential embodiment of the air mask system 100 of the present invention in accordance with the disclosed architecture and showing the inner surface 115 of the face mask 110 being in fluid communication with a portable pump 122. More specifically, the air mask system 100 is comprised of a face mask portion 110 an a portable pump 122. The face mask portion 110 is comprised of a lower edge 112, an upper edge 114, an inner surface 115, an outer surface 305, and a ridge for covering a bridge of a nose portion 116. The inner surface 115 of the face mask 110 is also provided with a support piece 118, which provides contour and shape to the face mask 110 as well as support for one or more filter elements 117. More specifically, each of the one or more filter elements 117 extend from the outer surface 305 of the face mask 110 to the inner surface 115, and provide an air egress port to allow expelled carbon dioxide an opportunity to exit from the interior side 115 of the face mask 110.

FIG. 1 also illustrates a length of flexible tubing 120, which extends along the top or upper edge 114 of the face mask 100, and is in fluid communication with the pump 122. More specifically, and as best shown in FIG. 2, the flexible tubing 120 is connected to the pump 122 via a T shaped member 124, wherein the tubing 120 is preferably comprised of a flexible material such as polyethylene, polypropylene or other polyester based material. The flexible tubing 120 may also be a medical grade tubing and is removable from the face mask 110 so that it may be cleaned or readily replaced after sufficient use of the face mask 110 has occurred. Further, the flexible tubing 120 is designed to encircle the user's head, but is not required to do so, and is further comprised of a plurality of openings (not shown) in the nose and mouth region of the face mask 110 to deliver air/oxygen generated by the pump 122 to the wearer.

FIG. 2 illustrates a perspective view of one potential embodiment of the portable pump 122 of the air mask system 100 of the present invention in accordance with the disclosed architecture, wherein the pump 122 is used to generate a positive air flow for the air mask system 110. The pump 122 may be any commercially available pump capable of pumping air into flexible tubing 120 and through the openings therein. As best shown in FIG. 2, the pump 122 may further comprise an ON/OFF switch 126 or other user operable controls, a battery compartment 128, a display 129 and a clip 130. More specifically, the ON/OFF switch 126 is used to put the pump 122 in an operative mode, or otherwise control its operation. For example, the pump 122 may be operated by a clock, timer, cycle counter or other device so that it regularly feeds fresh air into the region of the face mask 110 covering the nose and mouth of the wearer. The cycle driving of the pump 122 serves to force the exhaled air out of the face mask 110 to prevent the wearer from inadvertently rebreathing carbon dioxide and causing any additional respiratory distress as well as discomfort from the build-up of heat under the face mask 110 due to the exhaling of breath. The user can change the settings of the pump 122 to increase or decrease the cycling of the pump 122 in order to increase or decrease the flow of air coming into the nose and mouth region of the face mask 110.

The battery compartment 128 can be used to store a battery (not shown) therein for powering the portable pump 122. Notwithstanding, the pump 122 may also be powered by other sources including, without limitation, a solar panel, a photovoltaic panel, or other suitable power source. If a battery is used, it may be a disposable battery or a rechargeable battery, and may be easily replaced or removed if necessary, for recharging. The batteries can be selected from disposable batteries or rechargeable batteries; preferably double-A sized batteries in sufficient quantity to provide power to the pump 122. Suitable batteries include alkaline, nickel-cadmium, nickel-metal hydride, etc. Throughout this specification the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used. In a further embodiment of the present invention, it is also contemplated that the battery could be used to power small micro fans positioned in lieu of the filter elements 117 to expel the exhaled air from the interior portion of the face mask, to make it even easier for the wearer to breath while wearing the air mask system 100 of the present invention.

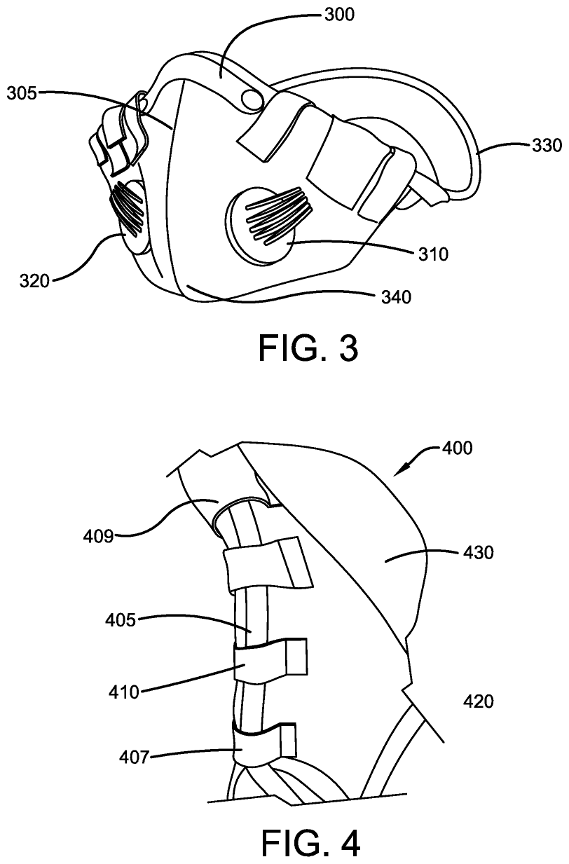

The pump 122 may also include a display 129 which may show the number of cycles of the pump 122, available life left on the battery, filter life, time of day, or other helpful information that may be of interest to the wearer. The clip 130 is useful for attaching the lightweight and portable pump 122 to the collar, neck or other apparel item so that the pump 122 may be easily and conveniently carried by the individual. The “T” connector 124 may be provided with ribs on each end so as to make a secure and tight fit with the flexible tubing 120 shown in FIG. 1. The generally “T” shaped connector 124 is also preferably comprised of a plastic such as polyethylene or medical grade plastic, and may be removed from the pump 122 for cleaning or replacement after a period of time. FIG. 2 also shows a better view of the filter 117 that is integral with the face mask 110 material. The filter element 117 preferably include a one-way or check valve, and air vents 322 to allow the expelled carbon dioxide to exit the interior area of the face mask 110 that covers the nose and mouth region of the individual wearer, as will be further described in FIG. 3. Because carbon dioxide is heavier than oxygen and will likely sink behind the mask, the air vents 322 are preferably located near the bottom of the face mask and below the user's mouth and nose.

FIG. 3 illustrates a perspective view of one potential embodiment of the outer surface 305 of the face mask portion 110 of the air mask system 100 of the present invention in accordance with the disclosed architecture. More specifically, nose piece 300 covers the bridge of the wearer's nose, and is generally deformable and made from a material that can be easily shaped. The material may be an aluminum strip or other shape memory material that can be molded to fit the nose of the wearer and hold the face mask 110 in proper position during use. In this particular embodiment, the face mask 110 comprises two filters 310, 320, each of which extend from the inner surface 115 of the face mask 110 to the outer surface 305 and have a series of vents 322 therein that allow for air to be expelled from the face mask system 100, and alternatively for air to be filtered into the interior portion of the face mask 110. Tubing 330 runs from the pump 122 to the top edge 114 of the face mask 110, and is connected to the nose piece 300 to provide fresh air in an area adjacent to the nose of the wearer. The face mask 100 may be manufactured as a single piece of material, or it may be joined together along a midpoint or seam 340 such as by sewing, bonding, adhesive, hook and loop fasteners or other suitable connectors.

In each of the various embodiments described herein, the face mask material itself may be comprised of one or more of a polypropylene, cotton, cotton polyester blends, natural and synthetic fibers, and/or combinations thereof. Nonetheless, the material selected should be comfortable to wear, and should easily fit on and cover the nose and mouth region of the wearer. Further, the face mask portion 110 is held in place by a pair of ear loops 121 (see e.g., FIG. 1) that extend outwardly from each side of the face mask 110 and loop around the ears of the wearer to secure the face mask 110 over the face of the wearer. Each of the ear loops 121 may be elastic or have stretchable qualities, thereby allowing the ear loops 121 to reach over the ears of the wearer without causing irritation thereto. The face mask material selected should also be of sufficient density to prevent the ingress of microbes and other contagions from passing from the environment into the interior of the face mask 110, and ideally a material that will keep out particles of 3 microns or larger in size.

FIG. 4 illustrates a partial perspective view of one potential embodiment of the face mask 400 of the air mask system 100 of the present invention in accordance with the disclosed architecture, and showing the multi-ply configuration of the face mask 400. More specifically, FIG. 4 illustrates a first layer 420 and a second layer 430 of face mask material. Each of the first and second layers 420, 430 may be separated from one another for easy cleaning and/or replacement. That is, the second layer 430 or inner most layer which is in contact with the face of the wearer may be removed for cleaning after prolonged exposure to the oils and other debris that may be generated by the skin of the wearer.

The first and second layers 420, 430 may be made of the same material, or different materials. For example, the first and outer most layer 420 may be made from a woven polypropylene material, which may prevent a smaller size of particulate to pass through than the inner most or second layer of material 430. The second layer of material 430 may be made of a softer material such as cotton, since it will be closer to, and typically adjacent, the face of the wearer.

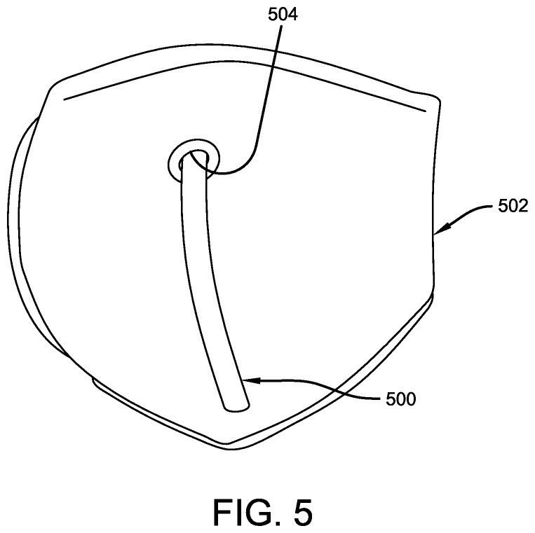

Additionally, the flexible tubing 405 is removably attached to, and held in place by, one or more loops 410 which are secured to the face mask 110 by fasteners, such as a hook and loop system, adhesive strips, snaps, buttons, clips, or the like. More specifically, the flexible tubing 405 is held along the upper edge of the face mask 407 and terminates at the nose piece 409. In this way, the air flow is brought directly to the region of the nose, thereby allowing fresh air to be breathed in by the user. In a further embodiment, it is also contemplated that aspects of the present invention can be utilized with, for example, an N95 or other face mask 502 via a simple adaptor or tube 500 that connects the N95 mask to the pump of the present invention, as best shown in FIG. 5. The tube 500 may be in communication with the space between the mask 502 and a user's face (not shown) via an opening 504 in the mask 502. More specifically, the present invention may be provided as a kit that includes the adaptor, thereby making it useable with other masks manufactured by third parties.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “face mask” and “air mask” are interchangeable and refer to improved personal protection equipment of the present invention.

Notwithstanding the forgoing, the various components of the air mask system 100 of the present invention can be of any suitable size and configuration as is known in the art without affecting the overall concept of the invention, provided that they accomplish the above stated objectives. One of ordinary skill in the art will appreciate that the size, configuration and material of the improved face mask system 100 and its various components shown in the FIGS. are for illustrative purposes only, and that many other sizes of personal protective equipment are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An air mask system comprising:
a face mask designed to cover a nose and a mouth region of a wearer, wherein the face mask is comprised of a pair of loops to hold the face mask in position over the nose and the mouth region, at least one woven or non-woven layer, a front surface, a back side, an upper edge and a lower edge;
at least one filter integrated into the face mask; and
a pump connected via a length of tubing to the face mask, wherein the pump provides a flow of air to the nose and mouth region of the wearer.

2. The air mask system as recited in claim 1, wherein the pump is a battery powered pump and includes a filter.

3. The air mask system as recited in claim 1 further comprising a one-way valve which closes at predetermined intervals.

4. The air mask system as recited in claim 3, wherein closure of the one-way valve prevents a build-up of carbon dioxide between the face mask and the wearer.

5. The air mask system as recited in claim 1, wherein the face mask comprises a nose piece and the length of tubing is connected to the face mask via the nose piece.

6. The air mask system as recited in claim 1, wherein the face mask comprises a first filter and a second filter separated by a seam in the face mask.

7. The air mask system as recited in claim 1, wherein the face mask is comprised of a first layer of material and a second layer of material, and further wherein the first layer of material is different than the second layer of material.

8. The air mask system as recited in claim 1, wherein the face mask is comprised of an internal support disposed on the back side of the face mask.

9. The air mask system as recited in claim 1, wherein the length of tubing is disposed along the upper edge of the face mask and held in position by a fastener.

10. The air mask system as recited in claim 2, wherein the filter for the pump further comprises a charcoal.

11. A combination pump and face mask comprising:
a face mask having a first side, a second side, a top edge, a bottom edge, and a pair of ear loops for holding the face mask over a portion of a face of a wearer; and
a pump connected to the face mask by a left tubing segment and a right tubing segment, wherein the pump is battery powered and comprises a filter containing a charcoal, and a one-way valve to facilitate removal of a carbon dioxide from inside the face mask.

12. The combination pump and face mask as recited in claim 11, wherein the face mask has a pair of filters disposed in the face mask and extending from the first side to the second side.

13. The combination pump and face mask as recited in claim 11, wherein the face mask is made from one of a woven or a non-woven material.

14. The combination pump and face mask as recited in claim 11, wherein the face mask is made from at least one of a polypropylene, a cotton, a cotton polyester blend, a natural and synthetic fiber, and a combination thereof.

15. The combination pump and face mask as recited in claim 11, wherein the pump releases a volume of air into the face mask in accordance with a controlled timer.

16. The combination pump and face mask as recited in claim 12, wherein each of the pair of filters in the face mask further comprise a vent.

17. A personal protection equipment comprising:
a face mask manufactured from one of a woven or a non-woven material, wherein the face mask is comprised of an outer surface, an inner surface, an upper edge, a lower edge, a pair of filters extending from the outer surface to the inner surface, and further wherein the face mask is sized and configured to cover a nose and a mouth region of an individual;
a nose piece provided on the upper edge of the face mask, wherein the nose piece is comprised of a first end and a second end with each of the first and second ends connected to a segment of flexible tube extending from the nose piece to around a head of the individual; and
a pump connected to the segment of flexible tube, wherein the pump is a source of fresh air to the inner surface of the face mask.

18. The personal protection equipment as recited in claim 17, wherein the pump comprises a filter material.

19. The personal protection equipment as recited in claim 17, wherein the pump is connected to the segment of flexible tube by a T-shaped pipe.

20. The personal protection equipment as recited in claim 17, wherein the face mask further comprises an inner face support disposed on the inner surface of the face mask.
